(19) United States
(12) Patent Application Publication
(10) Pub. No.: US 2009/0307033 A1
(43) Pub. Date: Dec. 10, 2009

(54) SYSTEM AND METHOD FOR PREVENTING DUPLICATE SURVEY ATTEMPTS

(75) Inventors: Ivan S. J. Pais, North Andover, MA (US); Nitin Patel, Andover, MA (US); David G. St. Pierre, North Andover, MA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Greenfield Online, North Andover, MA (US)

(21) Appl. No.: 12/470,088

(22) Filed: May 21, 2009

Related U.S. Application Data
(60) Provisional application No. 61/054,917, filed on May 21, 2008.

(51) Int. Cl. G06Q 10/00; G06F 17/30

(52) U.S. Cl. 705/7; 707/3; 707/104.1; 707/E17.044; 707/E17.014

(57) ABSTRACT

A system and method for detecting and avoiding attempts at taking the same survey by the same respondent. A respondent is assigned a Global unique identifier (GUID) and the encrypted global identifier is inserted in a “cookie” stored on the user's computer. Each time a respondent attempts to take a survey, a respondent is identified using a mechanism such as e-mail, computer identifier or the like and a Survey Management system checks to see if this respondent should have a global identifier encoded in a cookie. Based on this review, the Survey Management system can determine whether or not this particular user, whether using different computer systems or under different user accounts has previously taken the survey.

### CROSS-REFERENCE TO RELATED APPLICATIONS

The present application claims priority to U.S. Provisional Patent Application 61/054,917 filed on May 21, 2008 entitled “System and Method For Preventing Duplicate Survey Attempts”, which is incorporated fully herein by reference.

### TECHNICAL FIELD

The present invention relates to the taking of surveys and more particularly, to a system and method for preventing or minimizing a user's attempt at participating in a survey more than once.

### BACKGROUND INFORMATION

Surveys, focus groups, market research discussion sessions and the like (collectively referred to as “surveys” in this application), are well-known useful tools for a company to gauge the actual or potential success of a given product or service. Often times, surveys are used by a company to predict the likelihood of success with a given product or to gauge consumer interest in particular types of products, in order to ensure that only likely successful products are developed and marketed.

Surveys take on many forms including: verbal surveys (connected by telephone, door-to-door or on the street); written (mailed or handed to potential survey takers); and most recently and more predominantly electronic (by users who have access to a computer or other electronic devices and a network connection such as the Internet).

Potential survey participants or respondents are first identified from among a list or database of potential participants utilizing criteria established by the company or entity requesting the survey. Such criteria includes demographic information such as sex, age, income level, geographic region, residential living conditions (whether one owns or rents their primary residence), and any other factors perceived important such as known hobbies, schools attended, stores frequented, prior products purchased and the like.

Once potential survey participants have been identified, however, there is typically some form of enticement offered to the potential participants to encourage them to take part in a survey. The enticement is typically in the form of a payment, rebate, discount or other similar cash substitute. Because potential participants receive such an enticement, however, many participants attempt to take a survey multiple times in order to receive multiple enticements. Not only is this more costly for the entity ordering the survey but also survey results can be skewed by the same person taking the survey multiple times. Users may attempt to do this by using different computers, different log in names, and the like in an attempt to circumvent the limitation that a survey should be taken only once by every user.

Accordingly, what is needed is a system and method for eliminating or to at least to minimize the ability of the same user to take the same survey multiple times.

### BRIEF DESCRIPTION OF THE DRAWINGS

These and other features and advantages of the present invention will be better understood by reading the following detailed description, taken together with the drawings wherein:

FIG. 1 is it like diagram of an exemplary system with and on which may be implemented the present invention; and

FIGS. 2 & 3 are flow charts illustrating the actions taken by the system and method of the present invention in determining whether of not a respondent has already taken a given survey and whether or not they should be allowed to do so.

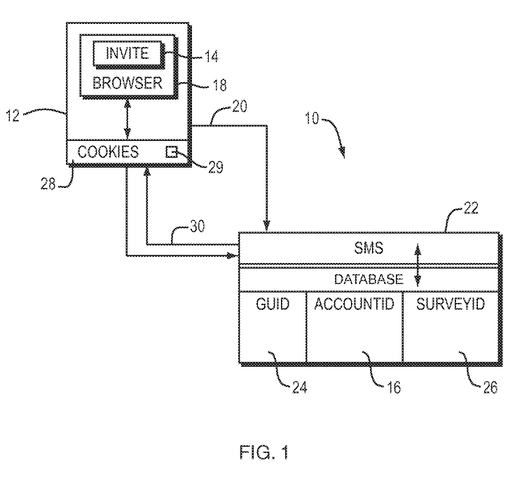

### DETAILED DESCRIPTION OF THE PREFERRED EMBODIMENTS

The present invention relates to a technique and appropriate system 101 FIG. 11 for preventing multiple respondents from taking the same online survey more than once using different identities on different computers within or across channels. A respondent in this context is any online (internet) user 12 that is willing to participate in taking an online survey.

A channel 14 in this context is defined as a source of traffic on the internet that brings a respondent to a survey. A channel can be, but is not limited to, an email invitation to a respondent that is a member of a panel (panelist), an advertisement on a web site that performs an html redirect, an integrated web site publisher that performs an html redirect, a panelist web site that presents survey opportunities, third party respondent providers that send respondents, etc.

An identity in this context is defined by the account that the respondent is using to take the survey under. A respondent may attempt to take surveys under multiple email accounts, different panel accounts, different publisher accounts, or different web accounts.

The technique described herein is and may be applied to all survey start landing pages used within, or as a result of, a channel 14. The detection technique described herein is executed whenever the landing page of the survey is loaded (http page load request), which occurs anytime a respondent attempts to take a survey. In addition, all registration systems utilize the technique through the use of a hidden image source containing a respondent unique identifier 16 (respondent GUID) that triggers the detection technique whenever a respondent registers with or otherwise enters the registration system.

Detection Technique

The detection technique of the present invention is triggered, as mentioned above, whenever a respondent responds to a survey opportunity (referred to as the Survey Start event) typically by clicking on the invitation of channel 14 through the user's computer browser 18. The Survey Start event causes an HTTP request 20 from the respondent's browser 18 to be made to the Survey Management system 22 to decide whether or not to present the survey to the respondent. The HTTP header of the request 20 from the respondent's browser 18 is checked for the existence of a previously issued Global Identifier cookie 29. The Global Identifier cookie 29 is a web cookie 28 (also known as an HTTP cookie and/or Flash Cookie, as both cookie types are used as part of the prevention technique of the present invention) as is known in the art, that is used to store an encrypted globally unique identifier (GUID) 24 that uniquely identifies the respondent from all other respondents independent of the account or machine that they are using to attempt to take the survey from.

A globally unique identifier or GUID is a special type of identifier used in software applications in order to provide a reference number which is unique in any context (hence, “globally”), for example, in defining the internal reference for a type of access point in a software application, or for creating unique keys in a database. While each generated GUID is not guaranteed to be unique, the total number of unique keys (2¹²⁸ or 3.4×10³⁸) is so large that the probability of the same number being generated twice is infinitesimally small. The Survey Management system 22 is responsible for issuing the Global Unique Identifier cookies each time a respondent attempts to take a survey. Each time a respondent attempts to take a survey, the Survey Management system 22 also records the Global Unique Identifier (GUID) 24 along with the Survey ID 26 and Account ID 16 so that the Survey Management System 22 knows whether the respondent has taken the survey already regardless of what account or machine they attempt to take the survey under.

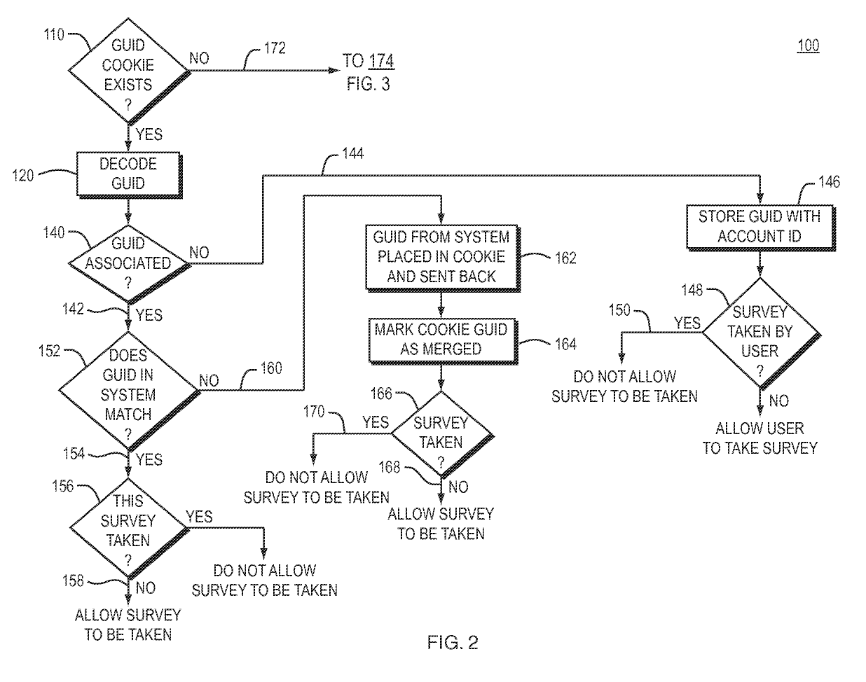

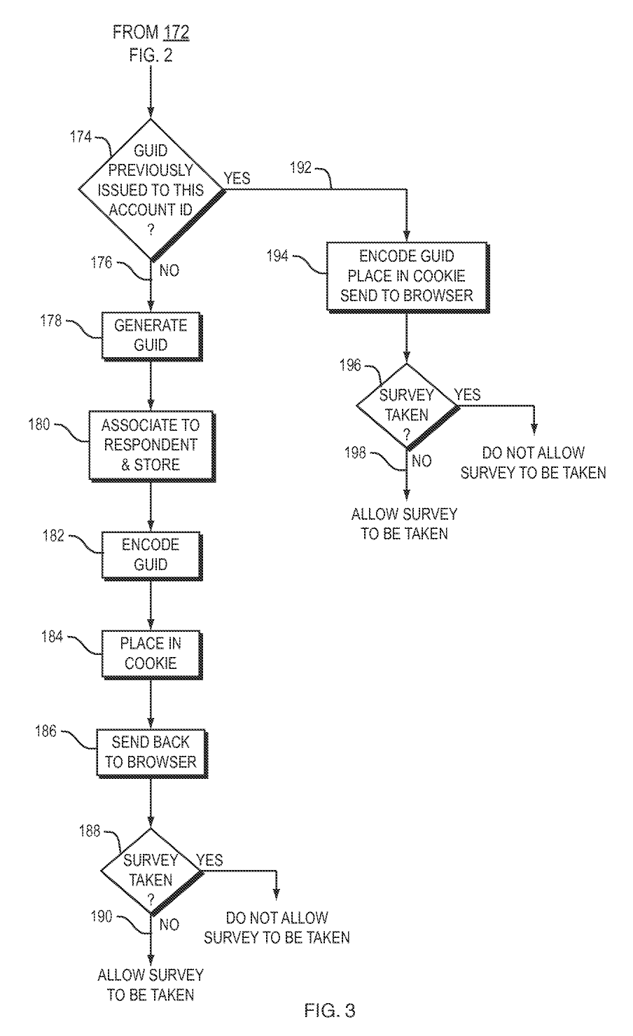

If the respondent's browser 18 is not configured to accept cookies, than the respondent is not allowed to take the survey. If the browser 18 does accept cookies 28, then the Survey Management system 22, typically computer software being executed on correspondingly appropriate computer hardware, performs the following detailed logic or activities described in relation to method 100 shown and described in FIGS. 2 and 3 as follows:
1) If the Global Identifier cookie 29 of the respondent exists on the respondent's computer system, act 110, then the global unique identifier 24 stored inside the cookie 29 is retrieved and decrypted, 120. If the respondent already has a global unique identifier 24 associated with them in the Survey Management system 22, path 142 from act 140, then one of two conditions can result:
   i. If they don't have a global unique identifier 24 associated to them in the Survey Management system 22 under the account identifier 16 they are presently trying to take this survey with, path 144, then the global identifier 24 from the cookie 29 is associated with the account identifier 16 and stored in the Survey Management system 22, act 146. If this respondent hasn't taken the particular survey 26 already under this account 16 or global unique identifier 24, path 148, then they are allowed to take the survey at this point. If the respondent already has taken the survey, under this account 16 or global unique identifier 24, path 150, they are not allowed to do so at this point.
   ii. If they do have a global unique identifier 24 associated to them in the Survey Management system 22, path 142, then the present invention checks to see if it matches the decrypted global unique identifier 24 in the cookie 29, act 152. 2 cases can arise at this point:
      a. If there is a match, path 154, no identification generation action is taken. This means that the respondent has been previously identified under this account on this machine and that they are not attempting to take the survey from a new account or machine. If this respondent hasn't already taken the survey associated with the survey ID 26 under this account ID 16 or global unique identifier 24, 156, then they are allowed to take the survey at this point, 158.
      b. If there is a mismatch (no match), path 160, then the respondent's global unique identifier 24 from the Survey Management system 22 is taken as the master and rewritten into the cookie 29 after encrypting, 162. All the respondent accounts and records that are associated with the global unique identifier 24 from the cookie in the Survey Management system 22 are changed to be associated with the global unique identifier from the respondent's record. The global identifier 24 from the cookie is also marked to have been ‘merged’ with the respondent's global identifier in the Survey Management system 22, so that if the respondent attempts any Survey Starts from different machines containing a different cookie's global unique identifier, the survey management system 22 can change it to the respondent's global identifier, act 164. Having done this, the system now has captured that a respondent using a different account or different machine is attempting to take a survey. If this respondent hasn't taken the particular survey already under this account or global identifier, act 166, then they are allowed to take the survey at this point, 168, or prevented from taking the survey, 170, if they have already done so.
2) If no cookie is detected in the HTTP header, path 172, FIG. 2, then the respondent's record for this account ID 16 in the Survey Management system 22 is checked to determine if a global unique identifier 24 was previously issued to the respondent based on the account ID 16 entered, act 174, FIG. 3. A cookie may not exist for this account ID 16 for several reasons: (1) it has not been issued yet because this is a first time respondent; (2) the respondent has deleted the global unique identifier containing cookie from his or her computer system; or (3) the respondent is using a different machine. Regardless, 2 cases can arise that are accounted for: i. If no global identifier has been previously issued, path 176, a new one is created, act 178 and then associated to the respondent in the Survey Management system database 22 for this account ID 16, act 180. The global unique identifier 24 is then encrypted or encoded, act 182, and set in the Global Identifier cookie 29, act 184 and sent on the HTTP response 30 back to the respondent's browser 18, act 186. The browser 18 then stores this cookie locally 28 to the respondent's machine 12. As a result, all future requests to the survey system from this machine 12 will contain this cookie 29 and GUID 24 in the HTTP header of the request. If this respondent hasn't taken the particular survey 26 already under this account 16, act 188, then they are allowed to take the survey at this point, 190.
   ii. If the global identifier has been issued to the respondent, path 192, then the identifier is then encrypted and set as the Global Unique Identifier cookie 29 on the HTTP response 30 back to the respondent's browser 18, 194. The browser 18 then stores this cookie locally 28 to the respondent's machine 12. As a result, all future requests to the survey system will contain this cookie 29 and GUID 24 in the HTTP header of the request. If this respondent hasn't taken the survey already under this account or global identifier, act 196, then they are allowed to take the survey at this point, 198.

Modifications and substitutions by one of ordinary skill in the art are considered to be within the scope of the present invention, which is not to be limited except by the allowed claims and their legal equivalents.

What is claimed is:

1. An automated survey management system, comprising:
an automated survey management system, coupled to the Internet, and configured for receiving survey taking requests from one or more survey respondents, each of said received survey taking requests including at least a respondent account identifier; and
wherein said automated survey management system includes:
at least one database, for storing said respondent account identifier in association with one or more survey identifiers and a global unique identifier, said one or more survey identifiers identifying which survey(s) has been previously taken by a respondent identified by said respondent account identifier, said global unique identifier providing a unique value associated with said respondent identified by said respondent account identifier; and
said automated survey management system further including a global unique identifier module, responsive to each said received survey taking request from a survey respondent, and configured for determining if said received survey taking request includes a global unique identifier previously stored on a computer, coupled to the Internet, and being used by a respondent to request taking a survey, and configured to be responsive to said determination of whether or not said received survey taking request includes a global unique identifier, for determining whether or not the respondent has previously taken the requested survey.

2. A method of determining whether a respondent requesting to take a survey has previously taken the survey, the method utilizing and automated survey management system and comprising the acts of:
providing an automated survey management system, coupled to the Internet, and configured for receiving survey taking requests from one or more survey respondents, each of said received survey taking requests including at least a respondent account identifier wherein said automated survey management system includes:
at least one database, for storing said respondent account identifier in association with one or more survey identifiers and a global unique identifier, said one or more survey identifiers identifying which survey(s) has been previously taken by a respondent identified by said respondent account identifier, said global unique identifier providing a unique value associated with said respondent identified by said respondent account identifier; and
responsive to each said received survey taking request from a survey respondent, automatically determining, by said survey management system, if said received survey taking request includes a global unique identifier previously stored on a computer, coupled to the Internet, and being used by a respondent to request taking a survey, and responsive to said determination of whether or not said received survey taking request includes a global unique identifier, automatically determining, by said survey management system, whether or not the respondent has previously taken the requested survey.

3. An automated survey management method utilizing an automated survey management system, for preventing duplicate attempts by a respondent attempting to take a survey from a computer system coupled to the Internet, said automated survey management system including a data base for storing respondent account information associated with previously taken the survey identification information and a global unique identifier string, said method comprising the acts of:
receiving, by said automated survey management system, a request from a respondent utilizing said computer system and coupled to the Internet to take a survey;
responsive to said received request, said automated survey management system determining whether said received request includes a global unique identifier contained in an Internet cookie as part of said received request;
responsive to a determination by said automated survey management system that said received request includes a global unique identifier cookie, decoding said presently received global unique identifier contained in said Internet cookie to provide a presently received decoded global unique identifier string;
responsive to said decoding, searching said automated survey management system database to determine if said respondent has an associated previously decoded global unique identifier string;
responsive to a determination that said respondent does not have an associated previously decoded global unique identifier string, automatically storing them by said automated survey management system of said decoded global unique identifier string in association with said respondent identifier in this said automated survey management system database;
responsive to a determination that said respondent does have an associated previously decoded global unique identifier string, determining if said presently received decoded global unique identifier string matches said previously decoded global unique identifier string associated with said respondent in said automated survey management system database;
responsive to a determination that said presently received decoded global unique identifier string matches said previously decoded global unique identifier string associated with said respondent, automatically determining, by said automated survey management system from said automated survey management system database if said respondent has previously taken the requested survey, and if said respondent has not previously taken the requested survey, allowing the respondent to do so and if said respondent has previously taken the requested survey, not allowing be responded to do so;
responsive to a determination that said presently received decoded global unique identifier string does not match said previously decoded global unique identifier string associated with said respondent, automatically encrypting and inserting said previously decoded global unique identifier string in said Internet cookie, automatically marking said Internet cookie as having a new global unique identifier string value and sending said Internet cookie with said previously decoded global unique identifier string to said respondent's computer system, and automatically determining, by said automated survey management system from said automated survey management system database, if said respondent has previously taken the requested survey, and if said respondent has not previously taken the requested survey, allowing the respondent to do so and if said respondent has previously taken the requested survey, not allowing be responded to do so;
responsive to a determination by said automated survey management system that said received request does not include a global unique identifier cookie, determining by said automated survey management system if a global unique identifier string was previously associated with the respondent's account identifier in said automated survey management system database;
responsive to said determination by said automated survey management system that a global unique identifier string was previously associated with the respondent' account identifier, encoding said associated global unique identifier string, placing said encoded global unique identifier string in an Internet cookie and returning said Internet cookie to said respondent's computer system, and automatically determining, by said automated survey management system from said automated survey management system database, if said respondent has previously taken the requested survey, and if said respondent has not previously taken the requested survey, allowing the respondent to do so and if said respondent has previously taken the requested survey, not allowing be responded to do so;
responsive to a determination by said automated survey management system that said received request does not include a global unique identifier cookie and to said determination by said automated survey management system that a global unique identifier string was not previously associated with the respondent' account identifier, generating, by said automated survey management system, a global unique identifier string, associating said generated global unique identifier string with said respondent and storing said global unique identifier string associated with said respondent in said automated survey management system database, encoding said associated global unique identifier string, placing said encoded global unique identifier string in an Internet cookie and returning said Internet cookie to said respondent's computer system, and automatically determining, by said automated survey management system from said automated survey management system database, if said respondent has previously taken the requested survey, and if said respondent has not previously taken the requested survey, allowing the respondent to do so and if said respondent has previously taken the requested survey, not allowing said respondent to do so.
